(19) United States
(12) Patent Application Publication
(10) Pub. No.: US 2020/0235815 A1
(43) Pub. Date: Jul. 23, 2020

(54) METHODS AND SYSEMS FOR RECONFIGURABLE NETWORK TOPOLOGIES

(71) Applicant: REFLEX PHOTONICS INC., Kirkland (CA)

(72) Inventor: David Robert Cameron ROLSTON, Beaconsfield (CA)

(21) Appl. No.: 16/639,699

(22) PCT Filed: Aug. 17, 2018
(86) PCT No.: PCT/CA2018/051002

§ 371 Date: Feb. 17, 2020

Related U.S. Application Data
(60) Provisional application No. 62/547,191, filed on Aug. 18, 2017.

(51) Int. Cl. H04B 10/27; H04Q 11/00; H04L 12/50

(52) U.S. Cl. CPC H04B 10/27; H04Q 11/0062; H04Q 2011/0081; H04Q 2011/009; H04L 12/50

(57) ABSTRACT

The present disclosure provides methods and systems for assigning a network topology to an interconnection network. Data is transmitted along at least one of a plurality of output ports based on a first port map, the first port map linking at least one of a plurality of input ports to at least one of the output ports. A request to apply a second port map, different from the first port map, is received. A circuit-switched element is activated to link at least one of the plurality of input ports to at least one of the plurality of the output ports based on the second port map. The data is transmitted along the at least one of the plurality of output ports based on the second port map.

### CROSS-REFERENCE TO RELATED APPLICATIONS

This application claims priority under 35 USC § 119(e) of U.S. Provisional Application 62/547,191, entitled “Methods and Systems for Reconfigurable Network Architectures”, filed Aug. 18, 2017, the contents of which are incorporated herein by reference.

### TECHNICAL FIELD

The present disclosure relates to optical communication devices, and more specifically to devices for routing optical communications between endpoints.

### BACKGROUND OF THE ART

With the expansion of telecommunications and the Internet, modern communication infrastructure grows increasingly complex and costly to setup and maintain. Computing centers and data centers include not only large numbers of routers, servers, and the like, but also must be wired together in order to permit communication between these different components. By some accounts, merely installing the cabling for an average size data center of 10,000 servers can require more than 10 man-years of work.

The time and cost associated with the proper wiring of a data center or other large communication infrastructure means any wiring mistakes are all the more costly to investigate and resolve. In addition, these expenses make the particular configuration of the data center effectively permanent. Although it is known that certain arrangements of servers and databanks can be more effective at certain types of computational tasks than others, the effort required to rewire a data center entails substantially static configurations for the connections between devices.

As such, there is a need for techniques for flexible wiring in communication infrastructure.

### SUMMARY

In accordance with a broad aspect, there is provided a method for assigning an architecture to an interconnection network, comprising: transmitting data along at least one of a plurality of output ports based on a first port map, the first port map linking at least one of a plurality of input ports to at least one of the output ports; receiving a request to apply a second port map different from the first port map; activating a circuit-switched element to link at least one of the plurality of input ports to at least one of the plurality of the output ports based on the second port map; and transmitting the data along the at least one of the plurality of output ports based on the second port map.

In accordance with another broad aspect, there is provided a method for assigning a topology to an interconnection network, comprising: transmitting data along at least one of a plurality of output ports based on a first port map, the first port map linking at least one of a plurality of input ports to the at least one of the plurality of output ports; receiving a request to apply a second port map different from the first port map; activating a circuit-switched element to link a subsequent at least one of the plurality of input ports to a subsequent at least one of the plurality of output ports based on the second port map; and transmitting the data along the subsequent at least one of the plurality of output ports based on the second port map.

In some embodiments, receiving the request comprises receiving the request via a wireless communication protocol.

In some embodiments, receiving the request comprises: interfacing with a control system via a wired communication port; and receiving the request from the control system via the wired communication port.

In some embodiments, the first port map links the at least one of a plurality of input ports to the at least one of the plurality of output ports in accordance with a first topology mapped onto the interconnection network, and wherein the second port map links the at least one of a plurality of input ports to the at least one of the plurality of output ports in accordance with a subsequent topology mapped onto the interconnection network, wherein the subsequent topology is different from the first topology.

In some embodiments, the subsequent topology comprises one of a hypercube topology, a two-dimensional torus topology, a tree topology, a butterfly topology, and a mesh topology.

In some embodiments, transmitting the data along the at least one of the plurality of output ports and/or the subsequent at least one of the plurality of output ports comprises transmitting from at least one of three input-output interfaces to at least one other one of the three input-output interfaces.

In some embodiments, the circuit-switched element is a cross-point switch.

In some embodiments, the interconnection network is an optical network.

In some embodiments, at least one of the first and second port maps links each of the plurality of input ports to a respective one of the plurality of output ports.

In some embodiments, at least one of the first and second port maps links one of the plurality of input ports to each of the plurality of output ports.

In some embodiments, the second port map causes a reconfiguration of a portion of the interconnection network relative to the first port map, wherein the portion is smaller than the complete interconnection network.

In some embodiments, one of the first port map and the second port map causes a plurality of portions of the interconnection network to implement different network topologies, wherein each portion is smaller than the complete interconnection network.

In accordance with another broad aspect, there is provided a device for assigning a topology to an interconnection network, comprising: a plurality of input ports configured for obtaining data; a plurality of output ports configured for transmitting the data; a circuit-switched element coupled to the plurality of input ports and to the plurality of output ports for linking the at least one of the plurality of input ports to at least one of the plurality of output ports based on the first port map; wherein the circuit-switch element is configured for altering links between the plurality of input ports and the plurality of output ports based on a subsequent port map.

In some embodiments, the device further comprises a wireless interface coupled to the circuit-switched element, wherein the circuit-switched element is configured for altering links between the plurality of input ports and the plurality of output ports in response to obtaining, from a control system via a wireless communication protocol, a request at the wireless interface.

In some embodiments, the device further comprises a wired interface coupled to the circuit-switched element, wherein the circuit-switched element is configured for altering links between the plurality of input ports and the plurality of output ports in response to obtaining, from a control system via a wired communication port, a request at the wired interface.

In some embodiments, the first port map links the at least one of a plurality of input ports to the at least one of the plurality of output ports in accordance with a first topology mapped onto the interconnection network, and wherein the second port map links the at least one of a plurality of input ports to the at least one of the plurality of output ports in accordance with a subsequent topology mapped onto the interconnection network, wherein the subsequent topology is different from the first topology.

In some embodiments, the subsequent topology comprises one of a hypercube topology, a two-dimensional torus topology, a tree topology, a butterfly topology, and a mesh topology.

In some embodiments, transmitting the data along the at least one of the plurality of output ports comprises transmitting from at least one of three input-output interfaces to at least one other one of the three input-output interfaces.

In some embodiments, the circuit-switched element is a cross-point switch.

In some embodiments, the interconnection network is an optical network.

In some embodiments, at least one of the first and second port maps links each of the plurality of input ports to a respective one of the plurality of output ports.

In some embodiments, at least one of the first and second port maps links one of the plurality of input ports to each of the plurality of output ports.

In some embodiments, the second port map causes a reconfiguration of a portion of the interconnection network relative to the first port map, wherein the portion is smaller than the complete interconnection network.

In some embodiments, one of the first port map and the second port map causes a plurality of portions of the interconnection network to implement different network topologies, wherein each portion is smaller than the complete interconnection network.

Features of the systems, devices, and methods described herein may be used in various combinations, and may also be used for the system and computer-readable storage medium in various combinations

### BRIEF DESCRIPTION OF THE DRAWINGS

Further features and advantages of embodiments described herein may become apparent from the following detailed description, taken in combination with the appended drawings, in which:

FIG. 1 is a block diagram of an example hybrid optical engine.

FIG. 2 is a flowchart illustrating an example method for assigning a topology to a wired packet-switched network according to an embodiment.

FIG. 3 is an example three-port switch based on the hybrid optical engine of FIG. 1.

FIG. 4 is an example server wiring setup.

FIGS. 5A-B are diagrams of example server configurations.

FIG. 6 is a diagram of a reconfigurable network.

It will be noted that throughout the appended drawings, like features are identified by like reference numerals.

### DETAILED DESCRIPTION

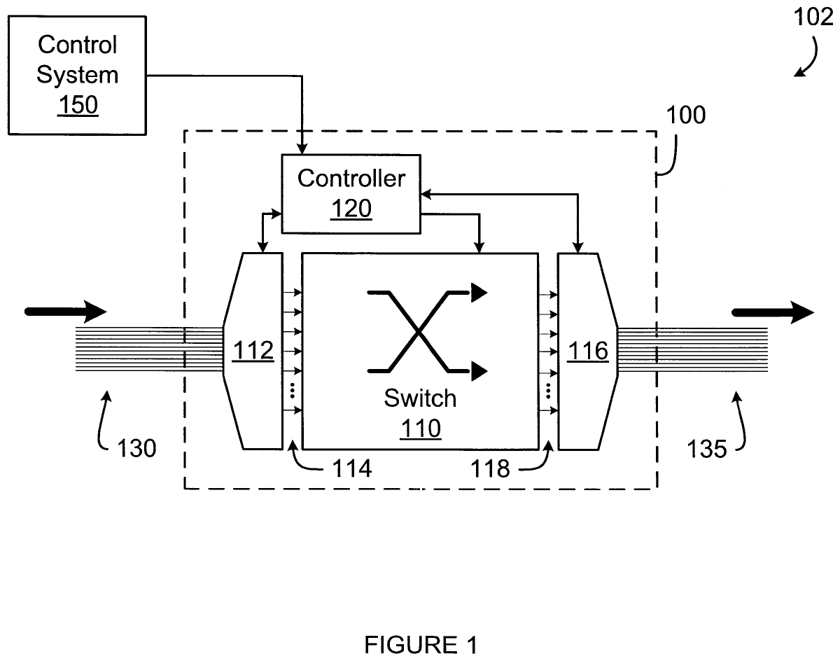

With reference to FIG. 1, there is shown a hybrid optical bridge (HOB) 100. The HOB 100 is configured for receiving and transmitting optical communication signals, which may come in the form of electrical or optical pulses, and may be electrical, single mode, multimode, or some combination thereof, and may be transmitted on any suitable frequency. The HOB 100 receives optical communication signals via one or more inputs 130, and transmits optical communication signals via one or more outputs 135. The inputs 130 and outputs 135 are cables, optical fibers, or other suitable communication media. The HOB 100 interfaces with any suitable number of inputs 130 and outputs 135. In some embodiments, twelve (12) inputs and outputs 130, 135 are provided.

Together, the HOB 100, the inputs 130, and the outputs 135 form part of an interconnection network 102. The interconnection network 102 may be a packet-switched network, a circuit-switched network, or any other suitable type of network. While the HOB 100 itself may remain protocol agnostic, it may be used to receive, send, generate, and/or process data, or to perform any suitable combination thereof. The interconnection network 102 may additionally include any number of servers, routers, databases, processing computers, and the like (not illustrated). In addition, in some embodiments the interconnection network 102 includes a plurality of HOBs 100, which can be placed in communication with any one or more of the servers, routers, databases, processing computers, etc. which are also part of the interconnection network 102. Examples of such embodiments are described herein below.

The HOB 100 is composed of a reconfigurable cross-point switch 110, an input interface 112, one or more input ports 114, an output interface 116, one or more output ports 118, and a controller 120. The input ports 114 are used to communicatively couple the input interface 112 to the switch 110. The output ports 118 are used to communicatively couple the switch 110 to the output interface 116. In some embodiments, the input and output ports 114, 118 have multiple channels per port. In other embodiments, each of the input and output ports 114, 118 has a single channel. Each channel may be a unidirectional path for the transfer of data, or may be a bidirectional path. Although illustrated here as separate elements, it should be noted that in some embodiments the input interface 112 and the input ports 114 can be implemented as substantially a single component, and the output interface 116 and the output ports 118 can also be implemented as substantially a single component.

The input interface 112 is configured to receive communication signals from the inputs 130, and the input ports 114 carry the signals from the input interface 112 to the switch 110. In some embodiments, the input interface 112 is configured to receive optical communication signals, for example by using a type of optical transceiver such as a QSFP or SFP module. The switch 110 transmits at least some of the signals received by the input interface 112 over the output ports 118 to the output interface 116. The signals are then output by the output interface 116 on the outputs 135. The controller 120 is configured for managing the operation of the switch 110, and the input and output interfaces 112, 116. Although the foregoing discussion focuses primarily on optical signals received by the input interface 112 and output by the output interface 116, it should be noted that the HOB 100 can also be configured to operate with electrical communication signals, such that electrical communication signals are received at the input interface 112 and transmitted at the output interface 116.

The switch 110 serves to reconfigure link assignments between at least some of the inputs 130 and the outputs 135 in accordance with a port map, which prescribes associations between the input ports 114 and the output ports 118. The port map is provided by the control system 150 to the controller 120, which causes the switch 110 to implement the links required by the port map. The switch 110 is a circuit-switched element, and can be implemented, for example, as a plurality of multiplexers, a cross-point switch, or any other suitable circuit-switched element. Once the switch 110 is set, optical communication signals received from the inputs 130 are transmitted to the outputs 135 according to the port map, via the input ports 114 and the output ports 118.

In some embodiments, the port map assigns each of the input ports 114 to a respective one of the output ports 118. In these embodiments, the port map is a one-to-one map. In other embodiments, the port map assigns one of the input ports 114 to a plurality of the output ports 118. In these embodiments, the port map is a one-to-many map. In further embodiments, the port map is used to cause the HOB 100 to implement a broadcast topology. Other assignments of input ports 114 to output ports 118 are also considered.

In some embodiments, a control system 150 is used to provide instructions to the controller 120 regarding the operation of the HOB 100. The control system 150 can be any suitable control system, and can be embodied in a smartphone app or other mobile application, a data centre control software running on a separate computer, or any other suitable computing device for interfacing with the HOB 100. In some embodiments, the control system 150 interfaces with the HOB 100 via a wired connection, for example RS-232, Ethernet, any suitable revision of the Universal Serial Bus (USB) standard, and the like. In other embodiments, the control system 150 interfaces with the HOB 100 via a wireless connection, for example using a WiFi, Bluetooth®, or ZigBee® protocol, or using any other suitable communication protocol. Still other types of control systems 150, as well as techniques for communication between the control system 150 and the HOB 100, are considered.

In some embodiments, the control system 150 is configured to control operation of many dozens or hundreds of HOBs 100 substantially simultaneously. For example, the control system 150 forms part of a network management layer for the interconnection network 102. In embodiments where a higher level network topology management control is implemented, the control system 150 accesses multiple remote HOBs 100 installed in the interconnection network 102. For example, communication with each HOB 100 device in the interconnection network 102 may be done using Wi-Fi addressing or sub-band carriers on the data lines, or dedicated, low-speed daisy-chain connections to each device. The control system 150 does not necessarily access the HOBs 100 often or at high-speed, since the HOBs 100 may only require reconfiguration periodically, depending on the load of the network or the applications running. In other embodiments, the control system 150 allows local-level access to control the HOB 100, for example via one or more wired connection protocols and the input and/or output interfaces 112, 116, through which one or more operators of the interconnection network 102 can change the port map of the HOB 100.

In embodiments where the control system 150 is used to control a large number of HOBs 100, different control schemes may be used. In some embodiments, the control system 150 uses sets of pre-defined port maps for links between inputs 130 and outputs 135 to define different types of connection schemes. The connection schemes may have been defined during an initial network planning stage for the interconnection network 102. For example, the pre-defined port maps target more specific applications and their optimized interconnection topologies. In other embodiments, the control system 150 performs slowly varying, but dynamic adjustments to the port map used in each HOB 100 based on congestion patterns for the flow of data in the interconnection network 102. For example, the port map used in each HOB 100 changes in response to fluctuation in traffic passed by other elements in the interconnection network 102. In some embodiments, the control system 150 causes the HOBs 100 to implement a reconfigurable optical add-drop multiplexer (ROADM) network, which balances load on long-haul networks. In some instances, algorithms used by the control system 150 in ROADM networks may occasionally require human intervention.

In other embodiments, the control system 150 is made up of a serial bus interface to the cross-point switch. The controller 120 may set up a static cross-configuration that routes a given set of the inputs 130 into the HOB 100 to a given set of the outputs 135 leaving of the HOB via the input and output ports 114, 118. This can be set up at the HOB 100 itself, either by way of a visual interface (OLED display) or using a USB connection, Wi-Fi or Bluetooth connection with a laptop or tablet.

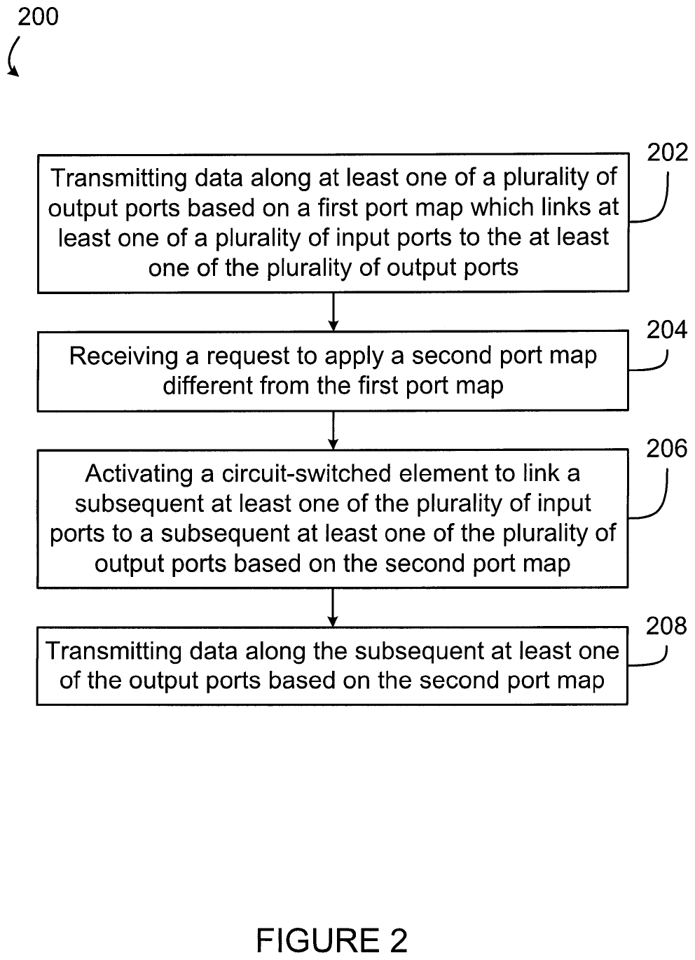

With reference to FIG. 2, the HOB 100 can be used to implement a method for assigning a topology to an interconnection network, for example the interconnection network 102. At step 202, data is transmitted along at least one of a plurality of output ports, for example the output ports 118, based on a first port map. The first port map links each one or more of a plurality of input ports, for example the input ports 114, to respective one(s) of the output ports 118. By extension, the first port map links the inputs 130 with the outputs 135, via the input and output interfaces 112, 116. The first port map can be any suitable port map, as disclosed hereinabove. In some embodiments, the data is packet-switched data. In addition, the packet-switched data can be any suitable data of any format, having any suitable word size, and being transmitted at any suitable bitrate.

At step 204, a request to apply a second port map is received. The request is received, for example, at the controller 120 from the control system 150, and may be received over a wired or wireless communication path, as described hereinabove. In some embodiments, the control system 150 communicates with the controller 120 over a USB connection, for example USB 2.0, 3.0, or using any other USB standard. In other embodiments, the control system 150 communicates with the controller 120 over a WiFi connection. The second port map is any suitable type of port map, and may differ from the first port map in any suitable fashion. For example, the first channel map is a one-to-one channel map where each of the input channels 114 is mapped to a respective one of the output channels 118. The second port map is a one-to-many port map where a single one of the input ports 114 is mapped to all of the output ports 118. Other examples are also considered.

At step 206, a circuit-switched element is activated to link at least one of the plurality of input ports 114 to respective one(s) of the output ports 118, based on the second port map. For example, the circuit-switched element is the switch 110, which can be a cross-point switch, a collection of multiplexers, and the like. The switch 110 is activated by the controller 120 to reassign the connections in the switch 110 such that the paths mapping the input ports 114 to the output ports 118 are aligned with the requirements of the second port map. It should be noted that the switch 110 does not perform any packet-based switching. That is to say, none of the switching/routing performed by the switch 110 is done on the basis of the information contained in the optical communication signals, but is done on the basis of ensuring that the input ports 114 and the output ports 118, and by extension the inputs 130 and outputs 135, are mapped to one another based on the appropriate port map.

At step 208, data is transmitted along the output ports 118 based on the second port map. By extension, the HOB 100 transmits data from the inputs 130 to the outputs 150 in accordance with the second port map. As above, the data may be packet-switched data, and the packet-switched data can be any suitable data of any format, having any suitable word size, and being transmitted at any suitable bitrate.

The HOB 100 provides a mechanism for flexible routing of optical communication signals without requiring rewiring of the interconnection network 102 or more complex packet-switching schemes. Wiring mistakes can be remedied by applying a port map which reassigns inputs 130 and outputs 150 as necessary, via the input and output ports 114, 118. If multiple HOBs 100 are used in a large interconnection network 102, the topology of the network can be altered by applying specific port maps to the HOBs 100. In this fashion, an interconnection network, for example the interconnection network 102, using a first set of port maps, for example which optimize the interconnection network 102 for cryptographic computation, can be assigned a new topology by using a second set of port maps, for example which optimize the interconnection network 102 for graphical processing.

In some embodiments, the interconnection network 102 is physically arranged to implement a particular network topology: that is to say, the physical layout and connection of the various devices which form the interconnection network 102 are disposed such that the interconnection network 102 implements a particular network topology. This can be a mesh topology, a ring topology, a tree or star topology, or any other suitable type of network topology. As used herein, this “physical topology” of the interconnection network 102 can be a base or original topology, and can be associated with a particular port map for the HOB(s) 100. For example, the HOB(s) can map each input port 114 to a respective output port 118, such that the indices of each of the ports 114, 118 are the same: the first input port 114 is mapped to the first output port 118, the second input port 114 is mapped to the second output port 118, and so on. Any subsequent port map for the HOB(s) 100 can alter the topology of the interconnection network 102 by varying the mapping of input ports 114 to output ports 118, thereby establishing a network topology for the interconnection network 102 which differs from the physical topology of the interconnection network 102. In some embodiments, the second port map can cause the network topology of only a portion of the interconnection network 102 (i.e., not the complete interconnection network 102) to be reconfigured.

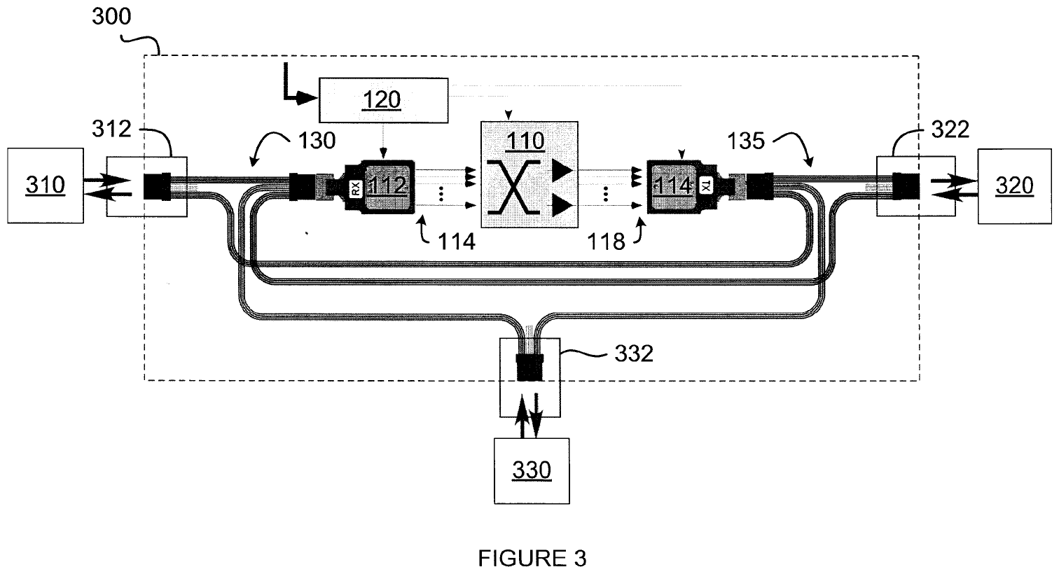

With reference to FIG. 3, an example three-port HOB 300 is shown. In this configuration, three separate devices 310, 320, 330 are configured for communicating with the three-port HOB 300, each via a separate input/output (I/O) interface. The first device 310 communicates with the three-port HOB 300 via I/O interface 312, the second device 320 communicates with the three-port HOB 300 via I/O interface 322, and the third device 330 communicates with the three-port HOB 300 via I/O interface 332. The three devices 310, 320, 330 may be servers, routers, databases, processing computers, and the like.

In this embodiment, the HOB 300 is configured for receiving optical communication signals over twelve (12) inputs 130, and each of the I/O interfaces 302, 304, 306 provides the HOB with four (4) of the twelve (12) inputs. Similarly, the three-port HOB 300 transmits optical communication signals over twelve (12) outputs, providing each of the I/O interfaces 302, 304, 306 with four (4) of the twelve (12) outputs. In other embodiments, the three-port HOB 300 is configured for receiving optical communication signals over more, or fewer, inputs 130, and for transmitting optical communication signals over more, or fewer, outputs 130. Each of the I/O interfaces 302, 304, 306 provides the three-port HOB 300 with a suitable number of the inputs 130 and outputs 135, as appropriate.

The three-port HOB 300 may be used to route communications between the three devices 310, 320, 330, based on the port map applied to the three-port HOB 300. For example, a first port map is used to provide inputs 130 from the first devices 310 to the second device 320, from the second device 320 to the third device 330, and from the third device 330 to the first device 310, along outputs 135. When the method 200 is performed to apply a second port map, inputs 130 from the first device 310 are instead provided to the third device 330, inputs 130 from the second device 320 are provided to the first device 310, and inputs 130 from the third device 330 are provided to the second device 320, each along outputs 135. Still other port maps can be implemented with the three-port HOB 300, and more complex communication topologies can be implemented by the use of multiple HOBs, including the HOB 100 and the three-port HOB 300. In addition, other implementations using similar HOBs as the HOB 100 and the HOB 300 may be used to route communications between more than three devices, including 4 or more devices, and any suitable radix can be applied to a HOB or a system using a HOB.

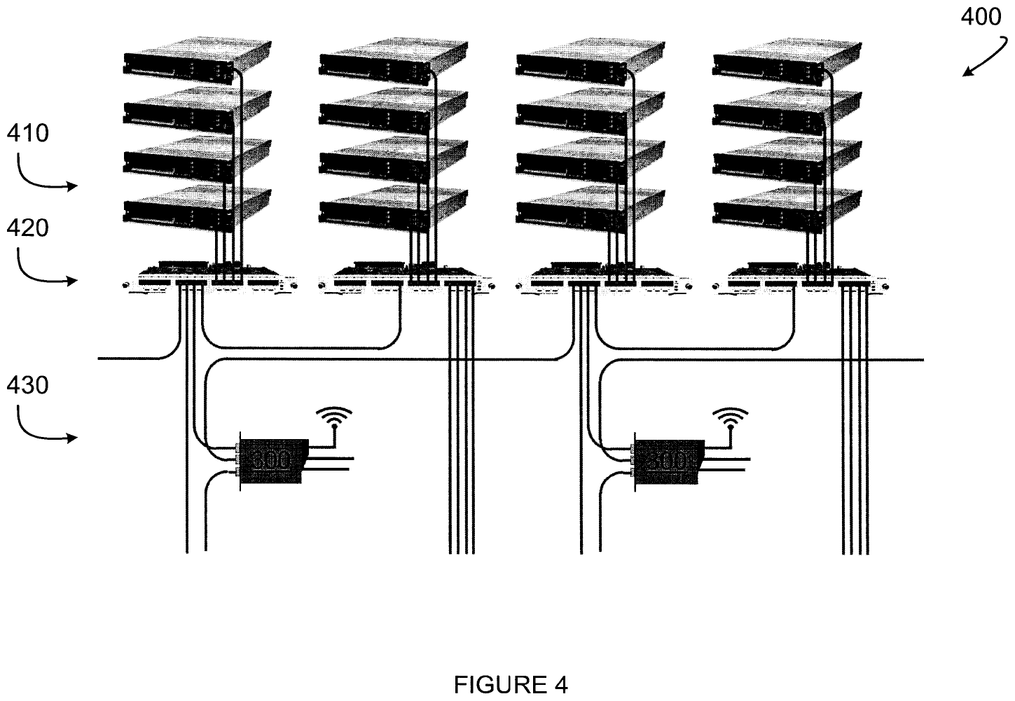

With reference to FIG. 4, an example server wiring diagram is illustrated. The server wiring diagram illustrates an example topology for a network 400, which may be an embodiment of the interconnection network 102 discussed hereinabove. The network 400 includes a plurality of servers 410, each of which is connected to one of a plurality of switches 420. In the embodiment shown in FIG. 4, each switch 420 is connected to four (4) servers 410, but it should be noted that other embodiments of the network 400 can have any suitable number of servers 410 connected to each switch 420.

In addition to the servers 410 and the switches 420, the network 400 includes a plurality of HOBs 300 located in an interconnect layer 430. The HOBs 300 of the interconnect layer 430 are connected to a plurality of the switches 420, and communications from at least some of the switches 420 are routed to other switches 420, or to other components of the network 400, via the HOBs 300. The interconnect layer can be used to alter the communication paths between the switches 420, thereby rearranging the topology of the network 400. It should be noted that the HOBs in the interconnect layer can also be the HOBs 100, or any other suitable embodiment of the HOB described herein.

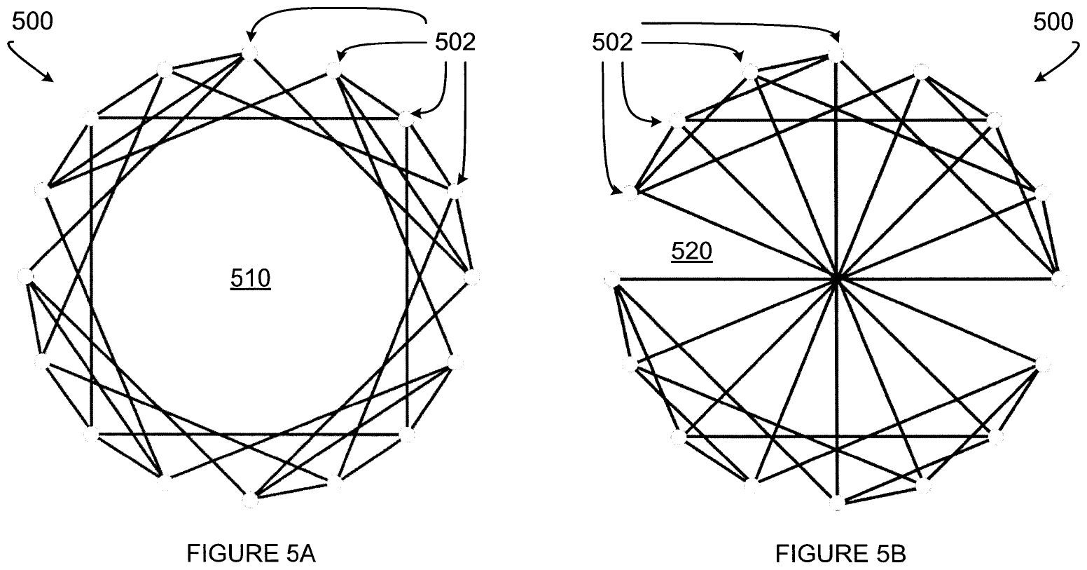

For example, and with reference to FIGS. 5A-B, a given interconnection network 500 can be provided with different topologies to perform different types of operations. The interconnection network 500 is shown as including a plurality of nodes 502, each of which can include one or more servers, one or more switches, and the like. In FIG. 5A, a first topology, called a hypercube topology 510, is applied to the network 500. In FIG. 5B, a second topology, called a two-dimensional torus topology 520, is applied to the network 500. However, without any HOBs in the network 500, it may be difficult to switch the connections in the network 500 between the topologies 510 and 520.

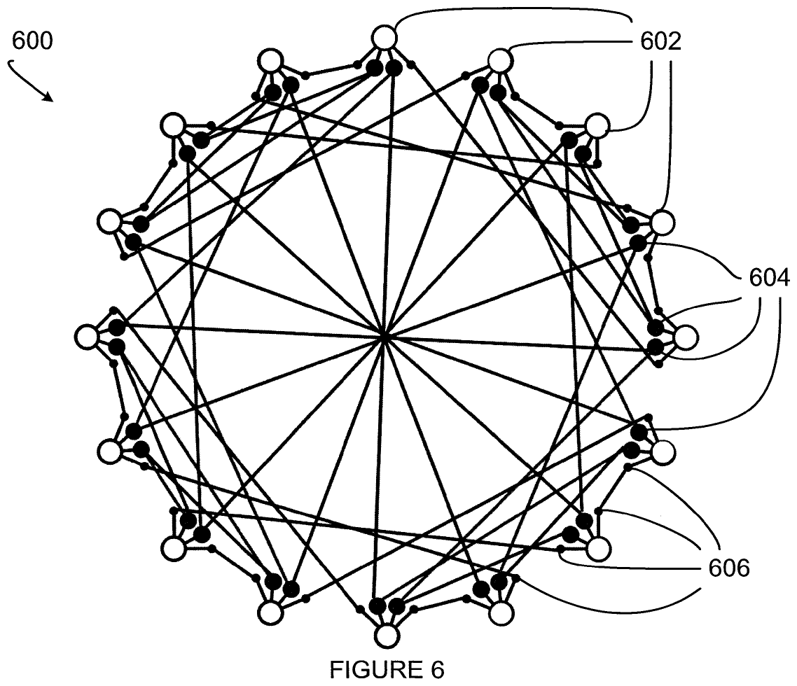

With reference to FIG. 6, an example network 600 is shown, having nodes 602, HOBs 604, and additional connections 606. The nodes 602 of the network 600 may be substantially similar to the nodes 502 of the network 500 of FIGS. 5A and 5B, and the HOBs 604 may be any suitable embodiment(s) of the HOB described herein. In some embodiments, the additional connections 606 are any suitable standard point-to-point connection used in interconnection networks. In other embodiments, the additional connections 606 are implemented via HOBs, which may be similar or dissimilar from the HOBs 604. In some cases, the network 600 illustrated in FIG. 6 is an alternative representation of the network 400 of FIG. 4, where the servers 410 and switches 420 are contained within each node 602.

The servers 602 of the network 600 are interconnected via the HOBs 604 and/or via the additional connections 606. In some embodiments, the HOBs 604 are connected to one another and the additional connections 606 are connected to one another, without any one of the HOBs 604 being connected to any one of the additional connections 606. In other embodiments, the HOBs 604 and additional connections 606 are connected together in any suitable fashion. In some embodiments, each of the HOBs 604 is provided with one connection for each of the different topologies to be applied to the network 600. In other embodiments, for example where certain connections between HOBs 604 are shared between topologies, each of the HOBs 604 is provided with fewer connections than the number of different topologies to be applied to the network 600.

Once the network 600 is connected, a first set of port maps applied to the HOBs 604 can apply a hypercube topology 510 to the network 400. A second set of port maps applied to the HOBs 604 can apply a two-dimensional torus topology 520 to the network 400. The network 400 can be reconfigured via the HOBs 604 by sending a request to apply a different port map to the HOBs 604. In addition to the hypercube 510 and two-dimensional torus 520, other topologies can be applied to the network 400, for example fat trees, hypertrees, or other types of tree networks, butterfly networks, mesh networks, whether full- or partial-interconnect, and the like. In some embodiments, the additional connections 606 are used to supplement the topologies provided by the connections between the HOBs 604. In other embodiments, the additional connections 606 are used to implement an alternative topology separate from those provided via the HOBs 604.

In some embodiments, the interconnection network 102 can be divided into one or more portions, each encompassing a subsection of the interconnection network 102, and each of the portions can be caused to implement different network topologies based on the applied port maps. For example, a first portion of the interconnection network 102 can implement a mesh network, a second portion of the interconnection network 102 can implement a ring network, and the like.

In some embodiments, the HOBs 100, 300 are housed in industry-standard 3U cassettes for ease of mounting in standard racks. In some embodiments, the HOBs 100, 300 are based on an optical-electrical-optical (OEO) regenerator card. Although the foregoing discussion has focused on optical communication signals, it should be noted that the principles described hereinabove could also be applied to systems using electrical signals, wherein the HOB 100 (or any other embodiment thereof) uses an electrical cross-point switch or plurality of multiplexers to effect the mapping of the input ports 114 to the output ports 118.

The HOBs 100, 300 may be used in any network that requires a large, complicated interconnection infrastructure. In some embodiments, the HOBs 100, 300 first serve to help reduce cabling errors during an initial cabling and installation of the network, as well as serve as an active element to test interconnection links by testing the bit-error rates of optical links connected via the HOBs 100, 300. In addition, in certain configurations, the HOBs 100, 300 are used to analyze data during initial diagnostics or trouble-shooting. This may dramatically reduce errors in cabling and poor performance which otherwise would increase costs to detect, analyze and fix the problems.

Although both data centers and computing centers can benefit from this installation flexibility, the HOBs 100, 300 can also serve to broadly reconfigure any network of which they are a part, either globally or locally, for example to optimize the interconnection topology used depending on types of processes and applications are being run on the network in real-time. As data centers begin to evolve towards more computation-based algorithms, a move from binary fat-tree interconnects may be required, and other topologies may be beneficial, for example hypercubes or dragonfly topologies. The network can then be optimized without physically sending people to touch or change physical connections. Any changes to the interconnects between network components can be done remotely and electronically, and be changed back depending on network usage.

The HOB may also include circuits to improve signal integrity such as clock-data-recovery circuits, pre-emphasis circuits or error-correction circuits. The HOB may also be able to recover data in one mode (such as multimode optical inputs) and re-transmit it in another mode (such as single mode optical outputs). The extension of multimode optical interconnects is also possible, allowing multimode optical links to be re-generated to extend their distance.

Various aspects of the methods and systems for assigning a topology to an interconnection network disclosed herein may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the preferred embodiments set forth in the examples, but should be given the broadest reasonable interpretation consistent with the description as a whole.

1. A method for assigning a topology to an interconnection network, comprising:
transmitting data along at least one of a plurality of output ports based on a first port map, the first port map linking at least one of a plurality of input ports to the at least one of the plurality of output ports;
receiving a request to apply a second port map different from the first port map;
activating a circuit-switched element to link a subsequent at least one of the plurality of input ports to a subsequent at least one of the plurality of output ports based on the second port map; and
transmitting the data along the subsequent at least one of the plurality of output ports based on the second port map.

2. The method of claim 1, wherein receiving the request comprises receiving the request via a wireless communication protocol.

3. The method of claim 1, wherein receiving the request comprises:
interfacing with a control system via a wired communication port; and
receiving the request from the control system via the wired communication port.

4. The method of claim 1, wherein the first port map links the at least one of a plurality of input ports to the at least one of the plurality of output ports in accordance with a first topology mapped onto the interconnection network, and wherein the second port map links the at least one of a plurality of input ports to the at least one of the plurality of output ports in accordance with a subsequent topology mapped onto the interconnection network, wherein the subsequent topology is different from the first topology.

5. The method of claim 1, wherein the subsequent topology comprises one of a hypercube topology, a two-dimensional torus topology, a tree topology, a butterfly topology, and a mesh topology.

6. The method of claim 1, wherein transmitting the data along the at least one of the plurality of output ports and/or the subsequent at least one of the plurality of output ports comprises transmitting from at least one of three input-output interfaces to at least one other one of the three input-output interfaces.

7. The method of claim 1, wherein the circuit-switched element is a cross-point switch.

8. (canceled)

9. The method of claim 1, wherein at least one of the first and second port maps links each of the plurality of input ports to a respective one of the plurality of output ports.

10. The method of claim 1, wherein at least one of the first and second port maps links one of the plurality of input ports to each of the plurality of output ports.

11. The method of claim 1, wherein the second port map causes a reconfiguration of a portion of the interconnection network relative to the first port map, wherein the portion is smaller than the complete interconnection network.

12. (canceled)

13. A device for assigning a topology to an interconnection network, comprising:
a plurality of input ports configured for obtaining data;
a plurality of output ports configured for transmitting the data;
a circuit-switched element coupled to the plurality of input ports and to the plurality of output ports for linking the at least one of the plurality of input ports to at least one of the plurality of output ports based on the first port map;
wherein the circuit-switch element is configured for altering links between the plurality of input ports and the plurality of output ports based on a subsequent port map.

14. The device of claim 13, further comprising a wireless interface coupled to the circuit-switched element, wherein the circuit-switched element is configured for altering links between the plurality of input ports and the plurality of output ports in response to obtaining, from a control system via a wireless communication protocol, a request at the wireless interface.

15. The device of claim 13, further comprising a wired interface coupled to the circuit-switched element, wherein the circuit-switched element is configured for altering links between the plurality of input ports and the plurality of output ports in response to obtaining, from a control system via a wired communication port, a request at the wired interface.

16. The device of claim 13, wherein the first port map links the at least one of a plurality of input ports to the at least one of the plurality of output ports in accordance with a first topology mapped onto the interconnection network, and wherein the second port map links the at least one of a plurality of input ports to the at least one of the plurality of output ports in accordance with a subsequent topology mapped onto the interconnection network, wherein the subsequent topology is different from the first topology.

17. The device of claim 13, wherein the subsequent topology comprises one of a hypercube topology, a two-dimensional torus topology, a tree topology, a butterfly topology, and a mesh topology.

18. The device of claim 13, wherein transmitting the data along the at least one of the plurality of output ports comprises transmitting from at least one of three input-output interfaces to at least one other one of the three input-output interfaces.

19. The device of claim 13, wherein the circuit-switched element is a cross-point switch.

20. (canceled)

21. The device of claim 13, wherein at least one of the first and second port maps links each of the plurality of input ports to a respective one of the plurality of output ports.

22. The device of claim 13, wherein at least one of the first and second port maps links one of the plurality of input ports to each of the plurality of output ports.

23. The device of claim 13, wherein the second port map causes a reconfiguration of a portion of the interconnection network relative to the first port map, wherein the portion is smaller than the complete interconnection network.

24. (canceled)
